(19) United States
(12) Patent Application Publication
(10) Pub. No.: US 2026/0121287 A1
(43) Pub. Date: Apr. 30, 2026

(54) ANTENNA STRUCTURE

(71) Applicant: Quanta Computer Inc., Taoyuan City (TW)

(72) Inventors: Kuan-Hsien LEE, Taoyuan City (TW); Chung-Ting HUNG, Taoyuan City (TW); Chin-Lung TSAI, Taoyuan City (TW); Yu-Chen ZHAO, Taoyuan City (TW); Chun-I CHENG, Taoyuan City (TW)

(21) Appl. No.: 18/979,901

(22) Filed: Dec. 13, 2024

(30) Foreign Application Priority Data
Oct. 28, 2024 (TW) 113211677

(51) Int. Cl. H01Q 1/48; H01Q 1/27; H01Q 1/50; H01Q 5/20

(52) U.S. Cl. CPC H01Q 1/48; H01Q 1/273; H01Q 1/50; H01Q 5/20

(57) ABSTRACT

An antenna structure includes a feeding radiation element, an extension radiation element, a grounding radiation element, and a carrier element. The feeding radiation element is coupled to a feeding point. The feeding radiation element substantially has a meandering shape. The extension radiation element is coupled to the feeding radiation element. The width of the extension radiation element is greater than that of the feeding radiation element. The grounding radiation element is coupled to a grounding point. The grounding radiation element is adjacent to the feeding radiation element. The feeding radiation element, the extension radiation element, and the grounding radiation element are disposed on the carrier element.

### CROSS REFERENCE TO RELATED APPLICATIONS

This application claims priority of Taiwan Patent Application No. 113211677 filed on Oct. 28, 2024, the entirety of which is incorporated by reference herein.

### BACKGROUND OF THE INVENTION

### Field of the Invention

The disclosure generally relates to an antenna structure, and more particularly, to a wideband antenna structure.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna for signal reception and transmission has an insufficient operational bandwidth, it may degrade the communication quality of the relative mobile device. Accordingly, it has become a critical challenge for designers to design a small-size, wideband antenna structure.

### BRIEF SUMMARY OF THE INVENTION

In an exemplary embodiment, the invention is directed to an antenna structure that includes a feeding radiation element, an extension radiation element, a grounding radiation element, and a carrier element. The feeding radiation element is coupled to a feeding point. The feeding radiation element substantially has a meandering shape. The extension radiation element is coupled to the feeding radiation element. The width of the extension radiation element is greater than the width of the feeding radiation element. The grounding radiation element is coupled to a grounding point. The grounding radiation element is adjacent to the feeding radiation element. The feeding radiation element, the extension radiation element, and the grounding radiation element are all disposed on the carrier element.

In some embodiments, the antenna structure further includes a transmission line. The transmission line is coupled to a signal source, and is disposed on the carrier element. The transmission line is implemented with a CPW (Coplanar Waveguide).

In some embodiments, the antenna structure further includes a matching circuit. The matching circuit is coupled to the transmission line, and is disposed on the carrier element. The matching circuit provides the feeding point and the grounding point.

In some embodiments, the feeding radiation element includes a first portion, a second portion, and a third portion. The second portion is coupled between the first portion and the third portion. The third portion is substantially parallel to the first portion.

In some embodiments, a first coupling gap is formed between the grounding radiation element and the first portion of the feeding radiation element. The width of the first coupling gap is from 1 mm TO 1.2 mm.

In some embodiments, a second coupling gap is formed between the grounding radiation element and the third portion of the feeding radiation element. The width of the second coupling gap is from 0.2 mm to 0.3 mm.

In some embodiments, the antenna structure covers a first frequency band, a second frequency band, and a third frequency band. The first frequency band is from 2400 MHz to 2500 MHz. The second frequency band is from 5150 MHz to 5850 MHz. The third frequency band is from 5925 MHz to 7125 MHz.

In some embodiments, the length of the extension radiation element is substantially equal to the length of the feeding radiation element.

In some embodiments, the total length of the feeding radiation element and the extension radiation element is substantially equal to 0.25 wavelength of the first frequency band.

In some embodiments, the length of the grounding radiation element is substantially equal to 0.25 wavelength of the second frequency band.

### BRIEF DESCRIPTION OF DRAWINGS

The invention can be more fully understood by reading the subsequent detailed description and examples with references made to the accompanying drawings, wherein:

FIG. 1 is a diagram of an antenna structure according to an embodiment of the invention;

FIG. 2 is a diagram of the return loss of an antenna structure according to an embodiment of the invention;

FIG. 3 is a diagram of an antenna structure according to an embodiment of the invention; and

FIG. 4 is a diagram of a wearable device according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to...”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

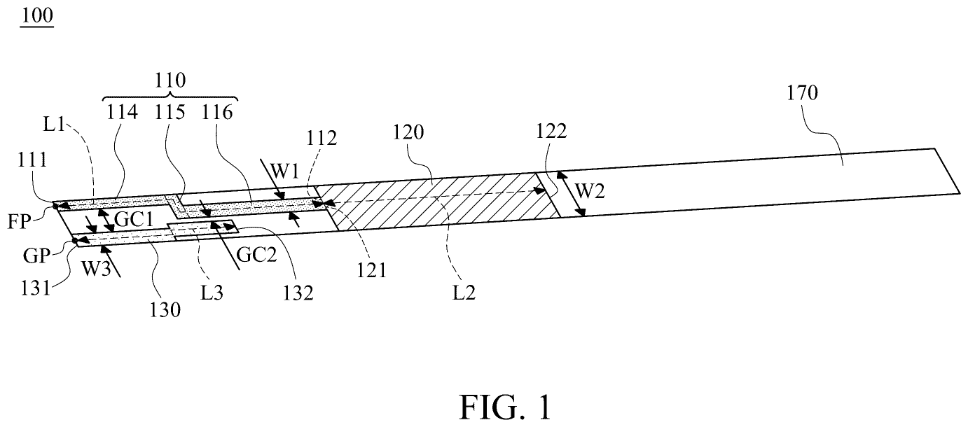

FIG. 1 is a diagram of an antenna structure 100 according to an embodiment of the invention. The antenna structure 100 may be applied to a mobile device, such as a smart phone, a tablet computer, a notebook computer, a wireless access point, a router, or any device with a communication function. Alternatively, the antenna structure 100 may be applied to an electronic device, such as any unit of IOT (Internet of Things).

As shown in FIG. 1, the antenna structure 100 includes a feeding radiation element 110, an extension radiation element 120, a grounding radiation element 130, and a carrier element 170. The feeding radiation element 110, the extension radiation element 120, and the grounding radiation element 130 may all be made of metal materials, such as copper, silver, aluminum, iron, or an alloy thereof.

The feeding radiation element 110 may substantially have a meandering shape, such as a Z-shape or an N-shape, but it is not limited thereto. Specifically, the feeding radiation element 110 has a first end 111 and a second end 112. The first end 111 of the feeding radiation element 110 is coupled to a feeding point FP. In some embodiments, the feeding radiation element 110 includes a first portion 114 adjacent to the first end 111, a second portion 115, and a third portion 116 adjacent to the second end 112. The second portion 115 is coupled between the first portion 114 and the third portion 116. In the feeding radiation element 110, the second portion 115 may be substantially perpendicular to both the first portion 114 and the third portion 116, and the third portion 116 may be substantially parallel to the first portion 114. It should be noted that the term “adjacent” or “close” over the disclosure means that the distance between (or the spacing of) two corresponding elements is smaller than a predetermined distance (e.g., 5 mm or the shorter), or means that the two corresponding elements directly touch each other (i.e., the aforementioned distance/space between them is reduced to 0).

The extension radiation element 120 may substantially have a relatively wide straight-line shape. Specifically, the extension radiation element 120 has a first end 121 and a second end 122. The first end 121 of the extension radiation element 120 is coupled to the second end 112 of the feeding radiation element 110. The second end 122 of the extension radiation element 120 is an open end. In some embodiments, the length L2 of the extension radiation element 120 is substantially equal to the length L1 of the feeding radiation element 110. In some embodiments, the width W2 of the extension radiation element 120 is greater than the width W1 of the feeding radiation element 110.

The grounding radiation element 130 may substantially have a relatively narrow straight-line shape (compared with the extension radiation element 120). Specifically, the grounding radiation element 130 has a first end 131 and a second end 132. The first end 131 of the grounding radiation element 130 is coupled to a grounding point GP. The second end 132 of the grounding radiation element 130 is an open end. For example, the second end 122 of the extension radiation element 120 and the second end 132 of the grounding radiation element 130 may substantially extend in the same direction. In some embodiments, the width W2 of the extension radiation element 120 is also greater than the width W3 of the grounding radiation element 130. In some embodiments, the grounding radiation element 130 is adjacent to the feeding radiation element 110. A first coupling gap GC1 may be formed between the grounding radiation element 130 and the first portion 114 of the feeding radiation element 110. A second coupling gap GC2 may be formed between the grounding radiation element 130 and the third portion 116 of the feeding radiation element 110.

In some embodiments, the feeding point FP is further coupled to a positive electrode of a signal source (not shown), and the negative electrode of the signal source is coupled to the grounding point GP. For example, the signal source may be an RF (Radio Frequency) module for exciting the antenna structure 100.

The feeding radiation element 110, the extension radiation element 120, and the grounding radiation element 130 may all be disposed on the same surface of the carrier element 170. The shape and type of the carrier element 170 are not limited in the invention. For example, the carrier element 170 may be an FR4 (Flame Retardant 4) substrate, a PCB (Printed Circuit Board), or an FPC (Flexible Printed Circuit). In some embodiments, the antenna structure 100 is a planar antenna structure. In alternative embodiments, the antenna structure 100 may be modified to a 3D (Three-Dimensional) antenna structure.

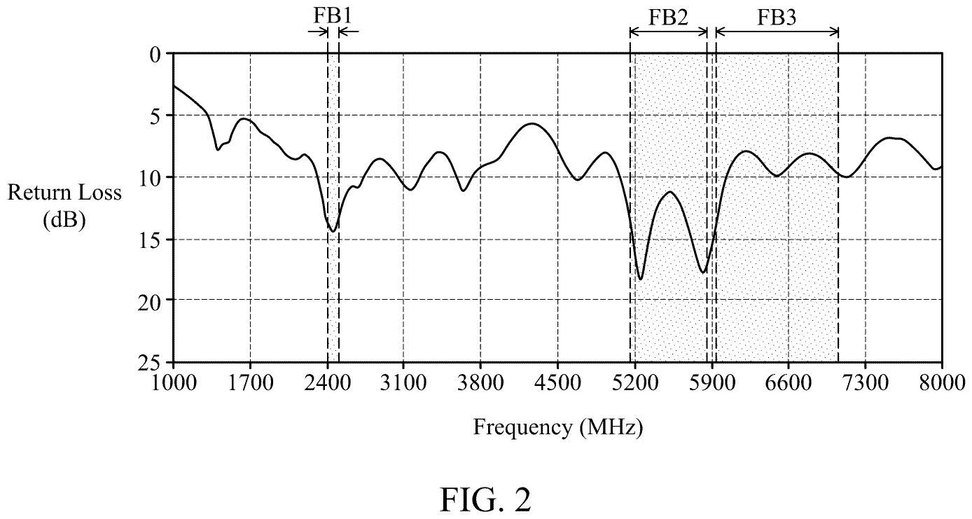

FIG. 2 is a diagram of the return loss of the antenna structure 100 according to an embodiment of the invention. The horizontal axis represents the operational frequency (MHz), and the vertical axis represents the return loss (dB). According to the measurement of FIG. 2, the antenna structure 100 can cover a first frequency band FB1, a second frequency band FB2, and a third frequency band FB3. For example, the first frequency band FB1 may be from 2400 MHz to 2500 MHz, the second frequency band FB2 may be from 5150 MHz to 5850 MHz, and the third frequency band FB3 may be from 5925 MHz to 7125 MHz. Therefore, the antenna structure 100 can support at least the wideband operations of WLAN (Wireless Local Area Network), Wi-Fi 6E, and Wi-Fi 7.

In some embodiments, the operational principles of the antenna structure 100 are described below. The feeding radiation element 110 and the extension radiation element 120 can be excited to generate the first frequency band FB1. The grounding radiation element 130 can be excited to generate the second frequency band FB2. In addition, a coupling effect can be induced between the grounding radiation element 130 and each of the feeding radiation element 110 and the extension radiation element 120, so as to generate the third frequency band FB3. According to practical measurements, the variable-width design of the feeding radiation element 110 and the extension radiation element 120 can be configured to increase the bandwidth of the first frequency band FB1.

In some embodiments, the element sizes of the antenna structure 100 are described below. The length L1 of the feeding radiation element 110 may be substantially equal to 0.125 wavelength (λ/8) of the first frequency band FB1 of the antenna structure 100. The width W1 of the feeding radiation element 110 may be from 0.5 mm to 1 mm. The length L2 of the extension radiation element 120 may be substantially equal to 0.125 wavelength (λ/8) of the first frequency band FB1 of the antenna structure 100. The width W2 of the extension radiation element 120 may be from 2.5 mm to 3 mm. The total length (L1+L2) of the feeding radiation element 110 and the extension radiation element 120 may be substantially equal to 0.25 wavelength (λ/4) of the first frequency band FB1 of the antenna structure 100. The length L3 of the grounding radiation element 130 may be substantially equal to 0.25 wavelength (λ/4) of the second frequency band FB2 of the antenna structure 100. The width W3 of the grounding radiation element 130 may be from 0.5 mm to 1 mm. The width of the first coupling gap GC1 may be from 1 mm to 1.2 mm. The width of the second coupling gap GC2 may be from 0.2 mm to 0.3 mm. The above ranges of element sizes are calculated and obtained according to many experimental results, and they help to optimize the operational bandwidth and the impedance matching of the antenna structure 100.

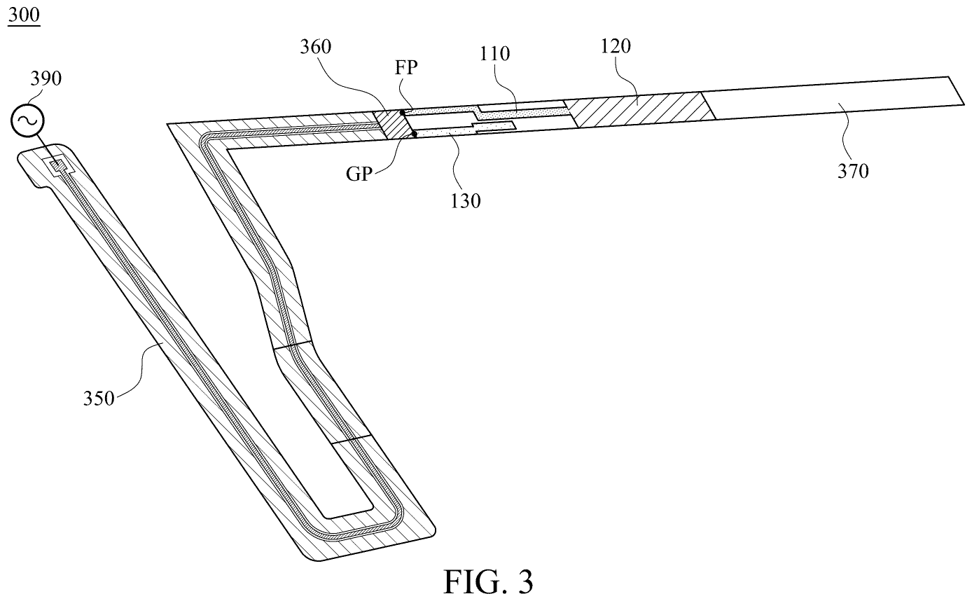

FIG. 3 is a diagram of an antenna structure 300 according to an embodiment of the invention. FIG. 3 is similar to FIG. 1. In the embodiment of FIG. 3, the antenna structure 300 further includes a transmission line 350 and a matching circuit 360. Both the transmission line 350 and the matching circuit 360 are disposed on a carrier element 370 of the antenna structure 300. The transmission line 350 is coupled to a signal source 390. For example, the transmission line 350 may be implemented with a CPW (Coplanar Waveguide). The matching circuit 360 is coupled to the transmission line 350. The matching circuit 360 can provide a feeding point FP and a grounding point GP. For example, the matching circuit 360 may be implemented with a π-shaped circuit, which may further include one or more inductors and/or one or more capacitors (not shown). Since the transmission line 350 is well integrated with the carrier element 370, the antenna structure 300 can effectively solve the problem of a conventional coaxial cable lacking of design flexibility. In addition, the matching circuit 360 can be configured to fine-tune the input impedance matching of the antenna structure 300. Other features of the antenna structure 300 of FIG. 3 are similar to those of the antenna structure 100 of FIG. 1. Accordingly, the two embodiments can achieve similar levels of performance.

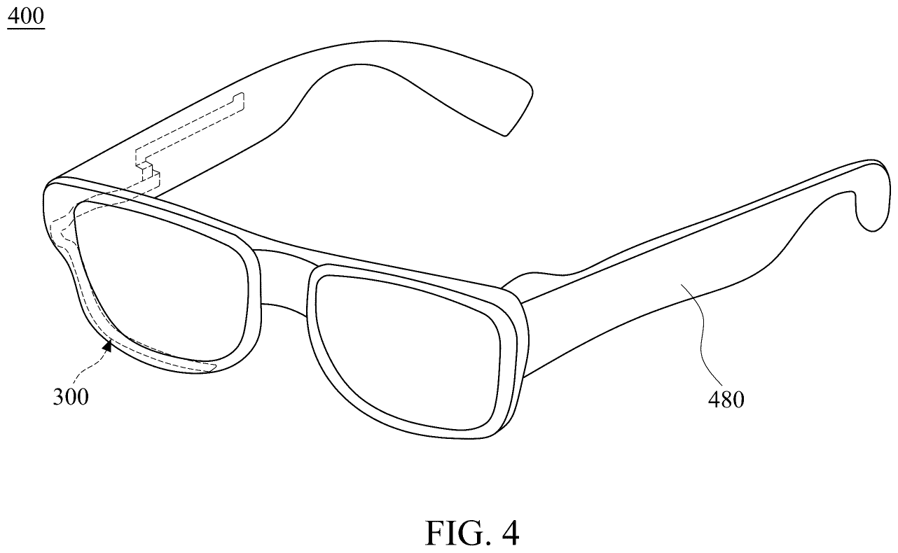

FIG. 4 is a diagram of a wearable device 400 according to an embodiment of the invention. In the embodiment of FIG. 4, the wearable device 400 is a pair of smart eyeglasses with the function of wireless communication, and includes a nonconductive frame element 480. The aforementioned antenna structure 300 (or 100) is disposed on the nonconductive frame element 480. For example, the aforementioned antenna structure 300 (or 100) may substantially extend along the nonconductive frame element 480. In alternative embodiments, the wearable device 400 further includes an RF circuit, a filter, an amplifier, and/or a processor, but it is not limited thereto.

The invention proposes a novel antenna structure. In comparison to the conventional design, the invention has at least the advantages of small size, wide bandwidth, and integration with a wearable device. Therefore, the invention is suitable for application in a variety of mobile communication devices or the IOT.

Note that the above element sizes, element shapes, and frequency ranges are not limitations of the invention. An antenna designer can fine-tune these settings or values to meet different requirements. It should be understood that the antenna structure of the invention is not limited to the configurations of FIGS. 1-4. The invention may merely include any one or more features of any one or more embodiments of FIGS. 1-4. In other words, not all of the features displayed in the figures should be implemented in the antenna structure of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna structure, comprising:
a feeding radiation element, coupled to a feeding point, wherein the feeding radiation element substantially has a meandering shape;
an extension radiation element, coupled to the feeding radiation element, wherein a width of the extension radiation element is greater than that of the feeding radiation element;
a grounding radiation element, coupled to a grounding point, wherein the grounding radiation element is adjacent to the feeding radiation element; and
a carrier element, wherein the feeding radiation element, the extension radiation element, and the grounding radiation element are disposed on the carrier element.

2. The antenna structure as claimed in claim 1, further comprising:
a transmission line, coupled to a signal source, and disposed on the carrier element, wherein the transmission line is implemented with a CPW (Coplanar Waveguide).

3. The antenna structure as claimed in claim 2, further comprising:
a matching circuit, coupled to the transmission line, and disposed on the carrier element, wherein the matching circuit provides the feeding point and the grounding point.

4. The antenna structure as claimed in claim 1, wherein the feeding radiation element comprises a first portion, a second portion and a third portion, the second portion is coupled between the first portion and the third portion, and the third portion is substantially parallel to the first portion.

5. The antenna structure as claimed in claim 4, wherein a first coupling gap is formed between the grounding radiation element and the first portion of the feeding radiation element, and a width of the first coupling gap is from 1 mm to 1.2 mm.

6. The antenna structure as claimed in claim 4, wherein a second coupling gap is formed between the grounding radiation element and the third portion of the feeding radiation element, and a width of the second coupling gap is from 0.2 mm to 0.3 mm.

7. The antenna structure as claimed in claim 1, wherein the antenna structure covers a first frequency band, a second frequency band, and a third frequency band, the first frequency band is from 2400 MHz to 2500 MHz, the second frequency band is from 5150 MHz to 5850 MHz, and the third frequency band is from 5925 MHz to 7125 MHz.

8. The antenna structure as claimed in claim 1, wherein a length of the extension radiation element is substantially equal to that of the feeding radiation element.

9. The antenna structure as claimed in claim 7, wherein a total length of the feeding radiation element and the extension radiation element is substantially equal to 0.25 wavelength of the first frequency band.

10. The antenna structure as claimed in claim 7, wherein a length of the grounding radiation element is substantially equal to 0.25 wavelength of the second frequency band.
